(19) United States
(12) Patent Application Publication
(10) Pub. No.: US 2011/0199444 A1
(43) Pub. Date: Aug. 18, 2011

(54) LIQUID EJECTING HEAD

(75) Inventor: Takashi ITO, Nagoya-shi (JP)

(73) Assignee: BROTHER KOGYO KABUSHIKI KAISHA, Nagoya-shi (JP)

(21) Appl. No.: 13/007,133

(22) Filed: Jan. 14, 2011

(30) Foreign Application Priority Data
Feb. 15, 2010 (JP) 2010-029799

(51) Int. Cl. B41J 2/175

(52) U.S. Cl. 347/93

(57) ABSTRACT

A liquid ejecting head having a liquid-flow space through which a liquid flows from a liquid supply source toward liquid-drop ejecting nozzles, a generally planar partition portion extending in a direction intersecting a vertical direction and partially defining the liquid-flow space, and further partially defining first and second chambers such that the two chambers are arranged in a horizontal direction on respective opposite sides of the partition wall, the first and second chambers having a larger dimension in the vertical direction than in the horizontal direction, in cross section taken in a plane parallel to the vertical direction and a direction of arrangement of the two chambers, and a planar filter fixed to the partition portion so as to extend in a direction intersecting the horizontal direction, along a surface of the partition portion and configured to capture foreign matters contained in the liquid in at least one of the two chambers.

### CROSS REFERENCE TO RELATED APPLICATION

The present application claims the priority from Japanese Patent Applications No. 2010-029799 filed Feb. 15, 2010, the disclosure of which is herein incorporated by reference in its entirety.

### BACKGROUND OF THE INVENTION

1. Field of the Invention

The present invention relates to a liquid ejecting head configured to eject droplets of a liquid such as an ink.

2. Description of Related Art

There is known an ink-jet head as an example of a liquid ejecting head, which includes a reservoir unit that temporarily stores an ink to be supplied from an ink tank and delivered to ink-ejecting nozzles. This reservoir unit includes a horizontally extending film, an inlet joint formed at one end of the film, and a filter disposed so as to extend in parallel to the film, and has a reservoir passage, a central communication hole in communication with the reservoir passage, and ink flow passages formed such that the ink which has entered into the reservoir unit through the inlet joint flows horizontally, then flows upwards through the filter, and then flows downwards into the reservoir passage through the central communication hole. The reservoir passage has a comparatively large surface area in cross section taken in a horizontal plane parallel to the film.

### SUMMARY OF THE INVENTION

The filter unit having the filter disposed so as to extend horizontally as described above tends to have a relatively large size in the horizontal plane if the filter is formed to have the cross sectional surface area large enough to effectively perform its filtering function to capture foreign matters such as air bubbles contained in the ink, and accordingly results in an undesirable increase in the size of the ink-jet head in the horizontal plane.

The reservoir unit described above suffers from another problem, that is, a problem of clogging of the filter with the captured foreign matters scattered over a comparatively large surface area in the horizontal plane. The clogging of the filter leads to a decrease in the effective surface area of the filter (surface area effective to capture the foreign matters), an increase in the ink flow resistance of the filter, and a consequent decrease of the rate of flow of the ink to the nozzles of the ink-jet head, eventually resulting in a failure of normal ejection of the ink from the nozzles. Since the filter is likely to be clogged over the relatively large surface area as described above, an ink circulation purging operation of the ink-jet head to cause positive flows of the ink along the filtering surface of the filter should be performed frequently, so that the efficiency of a printing operation of the ink-jet head tends to be lowered.

The present invention was made in view of the background art described above. It is therefore an object of the present invention to provide a liquid ejecting head which is configured to reduce its size in the horizontal plane and to reduce a chance of clogging of its filter with the foreign matters over a large surface area.

The object indicated above can be achieved according to the principle of this invention, which provides a liquid ejecting head comprising:

a structure defining a liquid-flow space through which a liquid flows from a liquid supply source toward a plurality of liquid-drop ejecting nozzles; a generally planar partition portion formed so as to extend in a direction intersecting a vertical direction and configured to partially define the liquid-flow space; the partition portion partially defining a first chamber and a second chamber such that the first and second chamber are arranged in a horizontal direction on respective opposite sides of the partition wall, the first and second chambers having a larger dimension in the vertical direction than that in the horizontal direction, in cross section taken in a plane parallel to the vertical direction and the horizontal direction of arrangement of the first and second chambers; and a planar filter fixed to the partition portion so as to extend in a direction intersecting the horizontal direction, along a surface of the partition portion, and configured to capture foreign matters contained in the liquid in at least one of the first and second chambers.

### BRIEF DESCRIPTION OF THE DRAWINGS

The above and other objects, features, advantages and technical and industrial significance of the present invention will be better understood by reading the following detailed description of a preferred embodiment of the present invention, when considered in connection with the accompanying drawings, in which:

FIG. 1 is a schematic side elevational view of an ink-jet type printer including an ink-jet head as a liquid ejecting head constructed according to a first embodiment of this invention;

FIG. 2 is a side elevational view of the ink-jet head of FIG. 1;

FIG. 3A is an exploded perspective of the ink-jet head of FIG. 1, and FIG. 3B is a cross sectional view taken along line B-B of FIG. 3A;

FIG. 4 is a plan view of a passage unit of the ink-jet head of FIG. 1;

FIGS. 5A, 5B and 5C are views indicating ink flows through the ink-jet head of FIG. 1 during a printing operation of the ink-jet head, wherein FIG. 5A is a fragmentary cross sectional view of a first chamber of a filter unit, and FIG. 5B is a fragmentary cross sectional view of a second chamber of the filter unit, while FIG. 5C is a fragmentary exploded perspective view of the filter unit and a reservoir unit;

FIGS. 6A, 6B and 6C are views indicating ink flows through the ink-jet head of FIG. 1 during a nozzle purging operation of the ink-jet head, wherein FIG. 6A is a fragmentary cross sectional view of the second chamber of the filter unit, and FIG. 6B is a fragmentary cross sectional view of the first chamber of the filter unit, while FIG. 6C is a fragmentary exploded perspective view of the filter unit and the reservoir unit;

FIGS. 7A and 7B are views indicating ink flows through the ink-jet head of FIG. 1 during a circulation purging operation of the ink-jet head, wherein FIG. 7A is a fragmentary cross sectional view of the second chamber of the filter unit, and FIG. 6B is a fragmentary cross sectional view of the first chamber of the filter unit; and

FIGS. 8A, 8B and 8C are views indicating ink flows through the ink-jet head of FIG. 1 during an inter-filter purging operation of the ink-jet head, wherein FIG. 8A is a fragmentary cross sectional view of the second chamber of the filter unit, and FIG. 8B is a fragmentary cross sectional view of the first chamber of the filter unit, while FIG. 8C is a fragmentary exploded perspective view of the filter unit and the reservoir unit.

### DETAILED DESCRIPTION OF THE PREFERRED EMBODIMENTS

The preferred embodiment of this invention will be described by reference to the accompanying drawings.

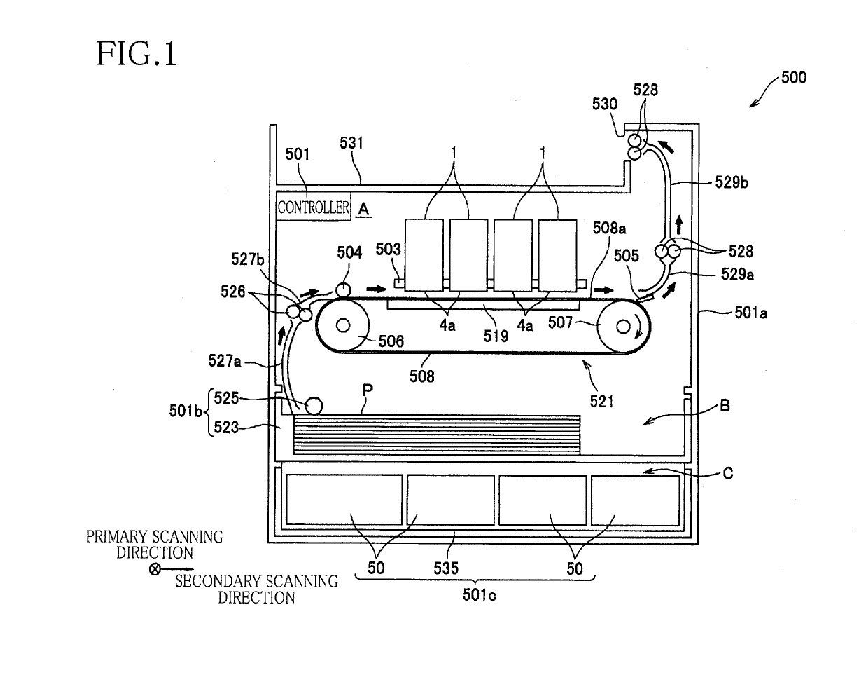

Referring first to the schematic side elevational view of FIG. 1, there is shown a printer 500 of an ink-jet type including four ink-jet heads 1 each constructed as a liquid ejecting head constructed according to the preferred embodiment of the present invention. Each of the ink-jet heads 1 is a so-called “line printing head” disposed so as to extend in one direction (direction perpendicular to the plane of the view of FIG. 1). That is, each ink-jet head 1 has its longitudinal direction that is a primary scanning direction, which is perpendicular to a secondary scanning direction in which the four ink-jet heads 1 are arranged in the ink-jet printer 500 of the line printing type.

The printer 500 has a housing 501a in the form of a generally rectangular parallelepiped having a top wall that serves as a sheet receiver 531. The housing 501a has three functional spaces A, B and C arranged in the order of description in the downward direction. A sheet transfer path along which a sheet of paper P is fed is formed through the functional spaces A and B and leads to the sheet receiver 531. In the functional space A, printing operations of the ink-jet heads 1 to print images on the paper sheet P are performed. In the functional space B, the paper sheets P are supplied one after another from a sheet supply tray 523 of a sheet supply unit 501b. In the functional space C, four ink cartridges (main tanks) 50 are disposed as ink supply sources.

In the functional space A, there are disposed the above-described four ink-jet heads 1, a sheet transfer unit 521, and sheet guide devices for guiding the paper sheet P. In an upper part of the functional space A, there is disposed a controller 501 for controlling operations of various devices of the printer 500.

Each ink-jet head 1 has a housing in the form of a generally rectangular parallelepiped the longitudinal direction of which is parallel to the primary scanning direction. The housing 501a has a head frame 503 supporting the four ink-jet heads 1 such that the four ink-jet heads 1 are arranged at a predetermined pitch in the secondary scanning direction. The four ink-jet heads 1 are supplied with respective four colors of ink, namely, magenta, cyan, yellow and black inks, as described below, and are configured to eject droplets of the respective colors of ink from their lower surfaces (ink ejecting surfaces) 4a toward the paper sheet P. The construction of each ink-jet head 1 will be described in more detail.

The sheet transfer unit 521 includes two belt rollers 506, 507, an endless conveyor belt 508 connecting the two belt rollers 506, 507, a nip roller 504 disposed adjacent to the belt roller 506, a sheet separator plate 505 disposed adjacent to the belt roller 507, and a platen 519 disposed within the loop of the conveyor belt 508. The belt roller 507 is a drive roller rotated clockwise as seen in FIG. 1 by a belt drive motor (not shown) under the control of the controller 501. As a result of the clockwise rotation of the belt roller 507, the upper span of the conveyor belt 508 is moved rightwards as indicated by arrows in FIG. 1. The belt roller 506 is a driven roller rotated clockwise as the conveyor belt 508 is rotated by the belt roller 507. The nip roller 504 cooperates with the belt roller 506 to press the paper sheet P onto an outer surface 508a of the conveyor belt 508 as the paper sheet P is fed from an upstream sheet guide device (described below). The outer surface 508a is coated with a slightly adhesive silicone layer. The sheet separator plate 505 disposed adjacent to the belt roller 507 functions to separate the paper sheet P from the outer surface 508a, so that the paper sheet P is fed toward a downstream sheet guide device (described below). The platen 519 is disposed below and in opposition to the four ink-jet heads 1, and functions to support the upper span of the conveyor belt 508 on its inner surface, so that a suitable amount of gap required to permit desired image forming operations of the ink-jet heads 1 is maintained between the outer surface 508a and the ink ejecting surfaces 4a of the ink-jet heads 1.

The upstream and downstream sheet guide devices are disposed on the respective opposite sides of the sheet transfer unit 521. The upstream sheet guide device includes two guides 527a, 527b, and a pair of feed rollers 526, and functions to guide the paper sheet P from the above-indicated sheet supply unit 501b to the sheet transfer unit 521. The downstream sheet guide device includes two guides 529a, 529b, and a pair of feed roller 528, and functions to guide the paper sheet P from the sheet transfer unit 521 to the sheet receiver 531. One of the two feed rollers 526, and one of the two feed rollers 528 are driven by a sheet feed motor (not shown) under the control of the controller 501. The guides 527a, 527b, 529a, 529b are arranged to guide the paper sheet P to and from the pairs of rollers 526, 528.

In the functional space B, there is disposed the above-indicated sheet supply unit 501b such that the sheet supply unit 501b is removable from the housing 501a. The sheet supply unit 501b includes the above-indicated sheet supply tray 523 and a sheet supply roller 525. The sheet supply tray 23 is a box having an upper opening, and accommodates a stack of paper sheets P. The sheet supply roller 525 is driven by a sheet supply motor (not shown) under the control of the controller 501, to feed the uppermost paper sheet P of the stack toward the upstream sheet guide device.

In the functional spaces A and B, the sheet transfer path is formed so as to extend from the sheet supply unit 501b to the sheet receiver 531 through the sheet transfer unit 521. The sheet supply motor, sheet feed motor and belt drive motor described above are driven under the control of the controller 501 according to printing control commands, so that the uppermost paper sheet P is fed by the sheet supply roller 525 from the sheet supply tray 523, fed by the feed rollers 526 to the sheet transfer unit 521, and fed by the conveyor belt 508 under the ink ejecting surfaces 4a of the ink-jet heads 1 in the secondary scanning direction while the ink droplets are ejected from the ink ejecting surfaces 4a, whereby the desired color images are printed on the paper sheet P. Subsequently, the paper sheet P is separated by the sheet separator plate 505 from the outer surface 508a of the conveyor belt 508, and is fed upwards by the pair of feed rollers 528 while the paper sheet P is guided by the guides 529a, 529b, and is ejected onto the sheet receiver 531.

The secondary scanning direction is a horizontal direction parallel to the direction of feeding of the paper sheet p by the sheet transfer unit 521, while the primary scanning direction is a horizontal direction perpendicular to the secondary scanning direction.

In the functional space C, there is disposed an ink unit 501c such that the ink unit 501c is removable from the housing 501a. The ink unit 501c includes a tank tray 535, and the above-indicated four main tanks (ink cartridges) 50, which are respectively used for the four ink-jet heads 1 and are arranged in the tank tray 535 in the secondary scanning direction. The ink is supplied from each of the main tanks 50 through a tube to the corresponding ink-jet head 1.

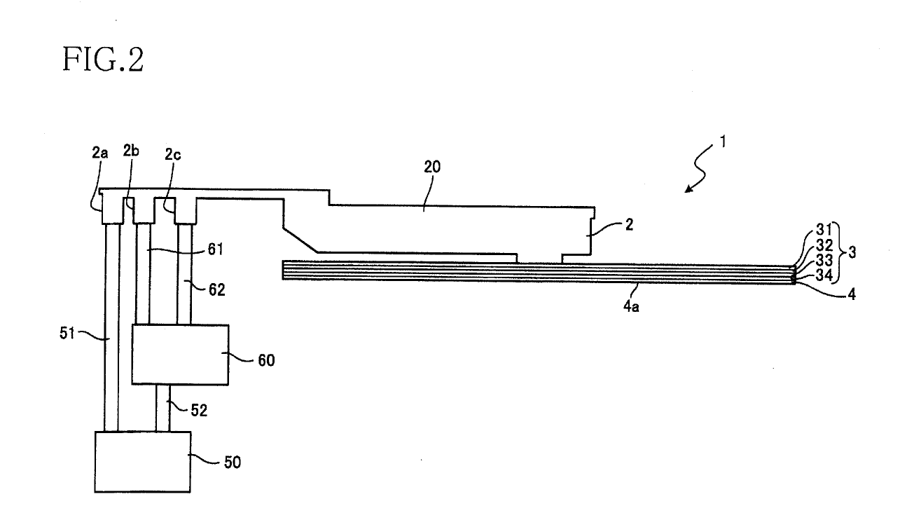

Referring nest to FIGS. 2-4, the construction of each ink-jet head 1 will be described. As shown in FIG. 2, the ink-jet head 1 includes a filter unit 2, a reservoir unit 3 and a passage unit 4, which are arranged in the order of description in the downward direction.

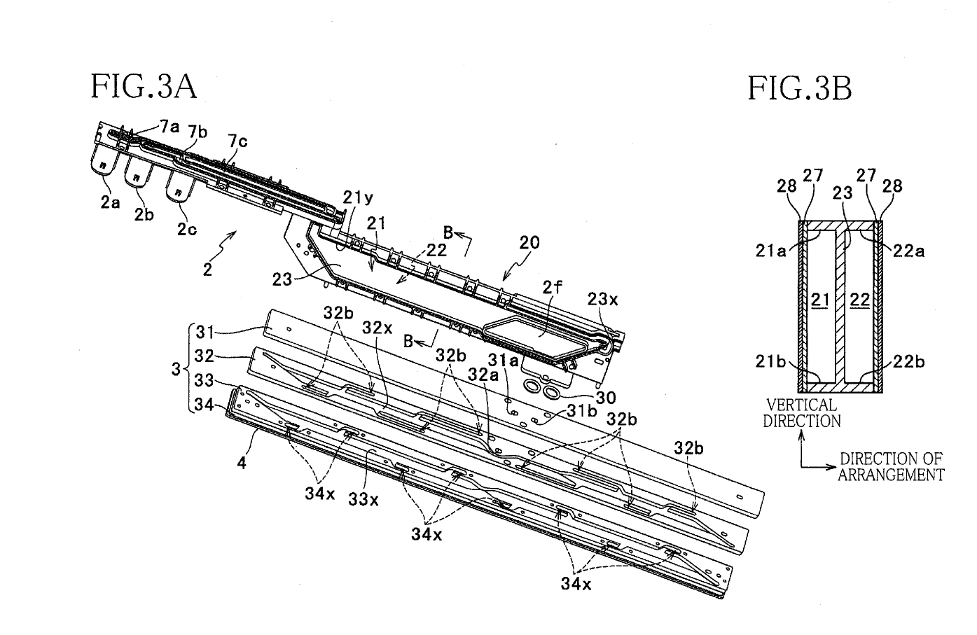

The filter unit 2 is a one-piece structure formed of a suitable material such as a synthetic resin. The filter unit 2 has a base portion 20 including three inlet joints 2a, 2b and 2c formed at one of its longitudinal ends, and a filter 2f (shown in FIG. 3A) at the other longitudinal end. The inlet joints 2a-2c take the form of downwardly extending sleeves to which elastic tubes 51, 61 and 62 are respectively connected. The filter unit 2 is connected to the main tanks 50 and an auxiliary tank 60 through the inlet joints 2a-2c and elastic tubes 51, 61, 62.

The main and auxiliary tanks 50, 60 serve as a liquid supply source, which store an ink of a color corresponding to the ink-jet head 1, and are held in communication with each other through an elastic tube 52. The main tanks (ink cartridges) 50 are removably installed in the housing 501a of the printer 500, as shown in FIG. 1, and supply the auxiliary tank 60 with the ink, as needed. The auxiliary tank 60 has a hole open to the atmosphere, through which air bubbles contained in the ink are released into the atmosphere. The auxiliary tank 60 is disposed at a suitable position within the housing 501a. The elastic tubes 51, 52, 61, 62 are provided with valves and pumps, which are controlled by the controller 501 (shown in FIG. 1) during a printing operation or purging operations of the ink-jet head 1, to feed the ink from the tanks 50, 60 to the filter unit 2 through the elastic tubes 51, 52, 61 62 and inlet joints 2a-2c, or to return the ink containing the air bubbles, dusts and other foreign matters, from the filter unit 2 back to the tanks 50, 60 through the inlet joints 2a-2c and elastic tubes 51, 52, 61, 62.

The construction of the filter unit 2 and flows of the ink during the printing and purging operations of the ink-jet head 1 will be described below in detail.

The reservoir unit 3 is a laminar structure consisting of four rectangular metal plates 31, 32, 33 and 34 which have the same surface area as seen in the horizontal plane and which are bonded together. As shown in FIG. 3A, the reservoir unit 3 is fluid-tightly fixed to the filter unit 2 through two O-rings 30 formed of a rubber or other elastic material, and by means of suitable fixing means.

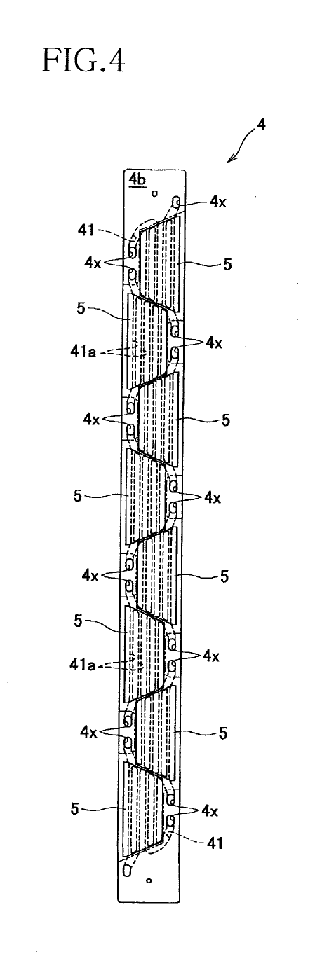

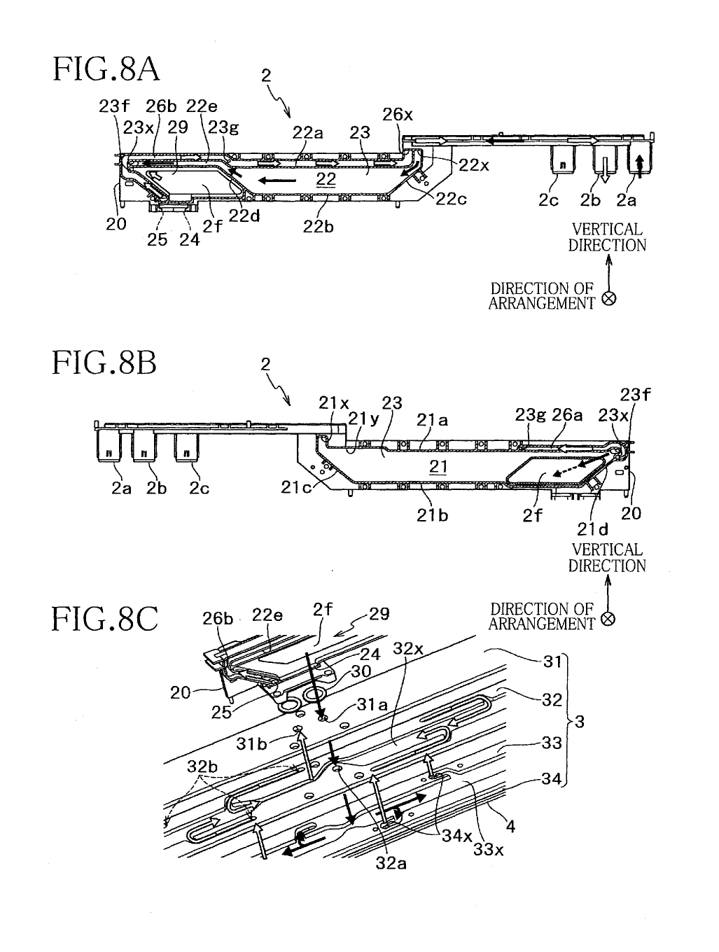

As also shown in FIG. 3A, each of the metal plates 31-34 of the reservoir unit 3 has through-holes and recesses for forming ink passages in the reservoir unit 3. Described more specifically, the uppermost metal plate 31 has two through-holes 31a and 31b, and the second metal plate 32 has a through-hole 32a communicating with the through-hole 31a, a recess 32x communicating with the through-hole 31b, and through-holes 32b formed in an end portion of each of branch grooves of the recess 32x. The through-hole 32a is held in communication with a reservoir 33x (described below), and the recess 32x is formed in the upper surface of the metal plate 32, so as to extend in the longitudinal direction of the ink-jet head 1, so that the ink containing the foreign matters flows through the recess 32x during an inter-filter purging operation of the ink-jet head 1, which will be described by reference to FIG. 8. The recesses 32b respectively communicate with the end portions of branch passages of the reservoir 33x. The third metal plate 33 has the above-indicated reservoir 33x, which temporarily stores the ink. The reservoir 33x is formed through the thickness of the third metal plate 33, so as to extend in the longitudinal direction of the ink-jet head 1. The end portions of the branch passages of the reservoir 33x are held in communication with the through-holes 32b formed in the end portions of the branch grooves of the recess 32 in the second metal plate 32 superposed on the third metal plate 33, and are aligned with respective through-holes 4x (shown in FIG. 4) formed through the passage unit 4 located below the third metal plate 33. The reservoir 33x are closed at its upper opening by the lower surface of the second metal plate 32, and at its lower opening by the upper surface of the fourth metal plate 34, except in the end portions of the branch passages of the reservoir 33x. The fourth metal plate 34 has through-holes 34x in communication with the above-indicated through-holes 4x formed through the passage unit 4, and with the end portions of the branch passages of the reservoir 33x.

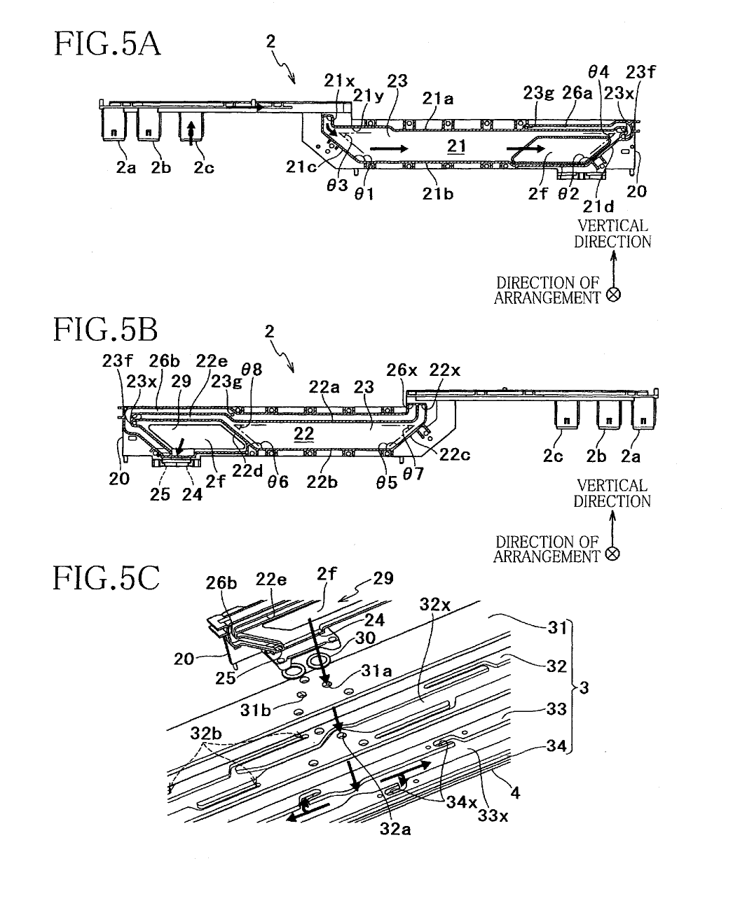

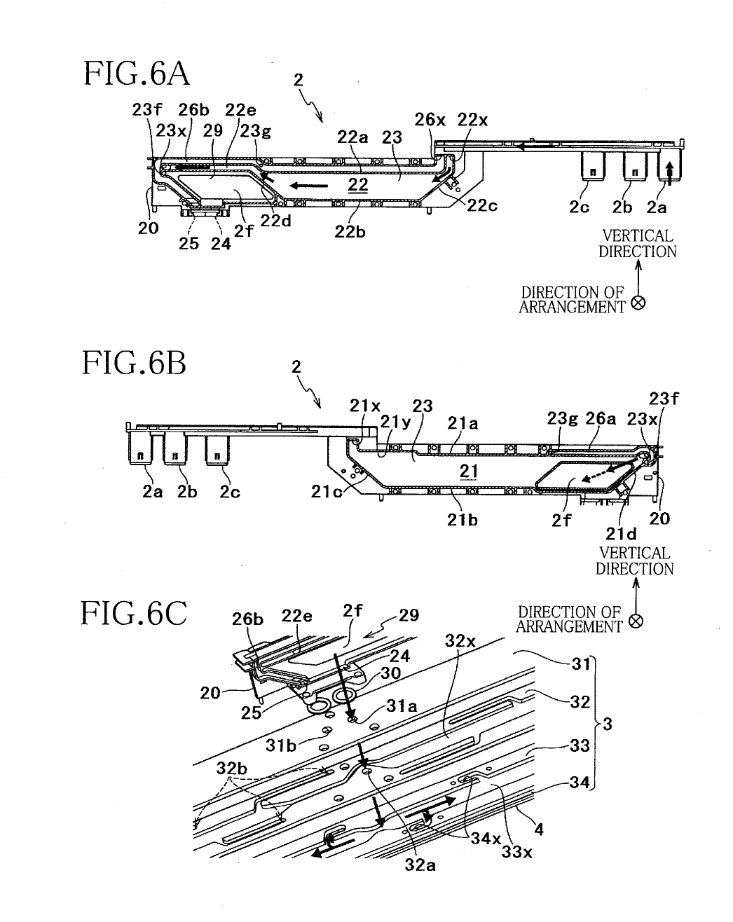

As described above, the reservoir unit 32 has an ink passage through which the ink fed from the filter unit 2 flows to the through-holes 4x of the passage unit 4. During the printing operation (described below by reference to FIG. 5) and a nozzle purging operation (described below by reference to FIGS. 6A-6C) of the ink jet head 1, the ink flows from the filter unit 2 through the through-holes 31a, 32a into the reservoir 33x, more specifically, into the branch passages of the reservoir 33x, and flows into the through-holes 4x of the passage unit 4 through the through-holes 34x. During the inter-filter purging operation (described by reference to FIGS. 8A-8C) of the ink-jet head 1, the ink fed into the reservoir 34x through the through-hole 32a flows from the branch passages of the reservoir 34x into the recess 32x through the through-hole 32b, and then into the filter unit 2 through the through-hole 31b.

As shown in FIG. 4, the passage unit 4 has eight piezoelectric actuator units 5 each having a trapezoidal shape, which are arranged in two rows in a zigzag fashion on its upper surface 4b. The through-holes 4x described above are formed in surface areas of the passage unit 4 outside the surface areas of the actuator units 5. In the surface areas of a lower surface 4a (shown in FIG. 2) of the passage unit 4 which correspond to the respective surface areas of the actuator unit 5, a multiplicity of ink ejecting nozzles (not shown) serving as liquid-drop ejecting nozzles are open for ejecting the ink droplets. The passage unit 4 has main manifold passages 41 in communication with the through-holes 4x, auxiliary manifold passages 41a in communication with the main manifold passages 41, and individual ink passages for communication between the auxiliary manifold passages 41a and the ink ejecting nozzles. As is apparent from FIG. 4, the auxiliary manifold passages 41a branch from the main manifold passages 41 in the longitudinal direction of the ink-jet head 1.

The lowermost metal plate 34 of the reservoir unit 3 is bonded at its lower surface to the upper surface 4b of the passage unit 4, except in the areas of the actuator units 5 (the areas indicated by two-dot chain lines in FIG. 4, which areas include the spots in which the through-holes 4x are open) of the passage unit 4. That is, the lower surface of the metal plate 34 has raised portions in the areas in which the through-holes 34x are formed and which are opposed to the areas of the passage unit 4 indicated by the two-dot chain lines in FIG. 4), and recessed portions in the other areas. The end surfaces of the raised portions on the lower surface of the metal plate 34 are held in abutting contact with the upper surface 4b of the passage unit 4. The recessed portions on the lower surface of the metal plate 34 are spaced by a small amount of gap from the upper surface 4b of the passage unit 4, the surfaces of the actuator units 5 bonded to the upper surface 4b, and the surface of a flexible printed circuit (not shown) bonded to the surfaces of the actuator units 5.

Referring to FIGS. 3A and 3B and FIGS. 5A-5C, the construction of the filter unit 2 will be described in detail.

As shown in FIG. 3A, the filter unit 2 includes a connecting portion having three connecting passages 7a, 7b and 7c connecting the inlet joints 2a-2c to first and second chambers 21 and 22 provided in the base portion 20. The connecting passage 7c connects the inlet joint 2c to the first chamber 21 while the connecting passages 7a and 7b connect the inlet joints 2a and 2b to the second chamber 22. The upper walls of the connecting passages 7a-7c are laminar structures similar to a laminar structure consisting of a flexible film 27 and a metal sheet 28 (which will be described by reference to FIG. 3B). Namely, each of the connecting passages 7a-7c is fluid-tightly sealed at its upper opening by the flexible film backed by the metal sheet. The metal sheet functions to prevent an excessive amount of outward flexure of the flexible film.

An interior space within the base portion 20 is divided into the above-indicated first and second chambers 21, 22 by a partition wall 23 which extends in the vertical direction, with the ink-jet head 1 installed in the printer 500 such that the lower surface 4a of the passage unit 4 extends in the horizontal direction. As indicated in FIG. 3B, the first and second chambers 21, 22 are arranged in the horizontal direction on the respective opposite sides of the partition wall 23. Each of the first and second chambers 21, 22 has a rectangular shape in cross section taken in a vertical plane parallel to the vertical direction of extension of the partition wall 23 and the direction of arrangement of the chambers 21, 22, as indicated in FIG. 3B. The rectangle of this cross sectional shape has a larger dimension in the vertical direction than that in the horizontal direction. One of the opposite long sides of the rectangle is defined by the partition wall 23 while the other long side is defined by the laminar structure of the flexible film 27 and metal sheet 28. The metal sheet 28 functions to prevent an excessive amount of outward flexure of the flexible film 27 and direct exertion of an external force onto the flexible film 27. It is noted that the flexible film 27 and metal sheet 28 are not shown in FIG. 3A.

The first and second chambers 21, 22 are held in communication with each other through a communication passage 23x which is formed through the partition wall 23 and which is a through-hole having a substantially circular cross sectional shape, as shown in FIG. 3A. The communication passage 23x is formed through an upper end portion of the partition wall 23 and at one of longitudinally opposite ends of the partition wall 23 which is remote from the inlet joints 2a-2c in the horizontal direction perpendicular to the vertical direction of extension of the partition wall 23 and the direction of arrangement of the two chambers 21, 22.

As shown in FIG. 5A, the first chamber 21 is partially defined by an upper wall 21a and a lower wall 21b both extending in the horizontal direction, and two end walls 21c and 21d which are inclined with respect to the vertical direction. The first chamber 21 has an inverted trapezoidal cross sectional shape as seen in the direction of arrangement of the two chambers 21, 22, as shown in FIG. 5A. An exhaust passage 26a is formed so as to surround the opening of the communication passage 23a on the side of the first chamber 21. The exhaust passage 26a is isolated from the first chamber 21 by a partition wall. The laminar structure of the flexible film 27 and metal sheet 28 (shown in FIG. 3B) is disposed in opposition to the partition wall 23 in the direction of arrangement of the two chambers 21, 22. The flexible film 27 of the laminar structure is fixed to the ends of the walls 21a-21d and the end of the side wall defining the exhaust passage 26a, such that the flexible film 27 partially defines the first chamber 21 and exhaust passage 26a.

The exhaust passage 26a is held in communication at its one end with an upper end portion of a filter chamber 29 (described below) through a through-hole 23f, and at the other end with an exhaust passage 26b (described below) through a through-hole 23g. The air bubbles accumulated in the upper portion of the filter chamber 29 are exhausted through the exhaust passage 26a.

As shown in FIG. 5B, the second chamber 22 is partially defined by an upper wall 22a and a lower wall 22b both extending in the horizontal direction, and two end walls 22c and 22d which are inclined with respect to the vertical direction. The second chamber 22 includes a main space having an inverted trapezoidal cross sectional shape as seen in the direction of arrangement of the two chambers 21, 22, as shown in FIG. 5B, and further includes a passage 22e communicating with the main space. The passage 22e extends from a part of the main space adjacent to the upper portion of the end wall 22d, in the longitudinal direction of the base portion 20, and is located at a vertical position higher than that of the main space, as seen in the vertical direction. Below the passage 22e, there is formed the above-indicated filter chamber 29, with a partition wall existing between the passage 22e and the filter chamber 29. The above-indicated exhaust passage 26b is formed so as to surround the second chamber 22 and the filter chamber 29. The laminar structure of the flexible film 27 and metal sheet 28 (shown in FIG. 3B) partially defining the second chamber 22 is also disposed in opposition to the partition wall 23 in the direction of arrangement of the two chambers 21, 22. The flexible film 27 of the laminar structure is fixed to the ends of the walls 22a-22d and the ends of the side walls defining the passage 22e, filter chamber 29 and exhaust passage 26b, such that the flexible film 27 partially defines the second chamber 22, filter chamber 29 and exhaust passage 26b. The exhaust passage 26b is provided to discharge the ink fed from the reservoir 33x and exhaust passage 36a, out of the ink-jet head 1.

Regarding the first chamber 21 shown in FIG. 5A, an angle of inclination θ1 of the end wall 21c with respect to the lower wall 21b, and an angle of inclination θ2 of the end wall 21d with respect to the lower wall 21b are both obtuse angles (e.g. about 140 degrees), while an angle of inclination θ3 of the end wall 21c with respect to the upper wall 21a, and an angle of inclination θ4 of the end wall 21d with respect to the upper wall 21a are both are both acute angles (e.g. about 40 degrees). Regarding the second chamber 22 shown in FIG. 5B, an angle of inclination θ5 of the end wall 22c with respect to the lower wall 22b, and an angle of inclination θ6 of the end wall 22d with respect to the lower wall 22b are both obtuse angles (e.g. about 140 degrees), while an angle of inclination θ7 of the end wall 22c with respect to the upper wall 22a, and an angle of inclination θ8 of the end wall 22d with respect to the upper wall 22a are both acute angles (e.g. about 40 degrees).

The obtuse angles of inclination θ1, θ2, θ5, θ6 of the end walls 21c, 21d, 22c, 22d with respect to the lower walls 21b, 22b permit smooth substantially horizontal flows of the ink through the first and second chambers 21, 22 in the longitudinal direction, without dwelling of the ink in the lower corner portions of the chambers 21, 22, and also permit smooth substantially horizontal flows of the air bubbles together with the ink, without dwelling of the air bubbles within the chambers 21, 22.

The first chamber 21 has an inlet opening 21x formed at its longitudinal end which is nearer to the inlet joints 2a-2c, that is, remote from the communication passage 23x, as shown in FIG. 5A. Through this inlet opening 21x, the first chamber 21 is held in communication with the connecting passage 7c (shown in FIG. 3A). The upper wall 21a provides a recessed portion 21y within the first chamber 21, as also shown in FIG. 5A. The recessed portion 21y is formed adjacent to the inlet opening 21x, so as to extend from the inlet opening 21x in the downstream direction. The recessed portion 21y functions to temporarily capture the air bubbles contained in the ink which has entered into the first chamber 21 through the inlet opening 21x, so that the air bubbles are prevented from flowing toward the filter 2f.

The above-indicated main space of the second chamber 22 has an inlet opening 22x formed at its longitudinal end which is nearer to the inlet joints 2a-2c, that is, remote from the communication passage 23x, as shown in FIG. 5B. Through this inlet opening 22x, the main space is held in communication with the connecting passage 7a (shown in FIG. 3A). As also shown in FIG. 5B, the main space of the second chamber 22 is held in communication with the above-indicated passage 22e, at its upper end and at its longitudinal end remote from the inlet opening 22x. At the end of the passage 22e remote from the main space, the passage 22e is held in communication with the communication passage 23x. The filter chamber 29 partially defined by the lower wall of the passage 22e and the end wall 22d of the main space has a parallelogram cross sectional shape as seen in the direction of arrangement of the two chambers 21, 22, as shown in FIG. 5B. The shape of the filter chamber 29 is substantially identical with the shape of the filter 2f, and the size of the filter chamber 29 is larger than that of the filter 2f.

The partition wall 23 has an opening formed therethrough, at which the filter 2f is disposed such that the filter 2f is fixed at its peripheral portion to a portion of the partition wall 23 which defines the opening. The filter 2f is a meshed planar member configured to capture the foreign matters in the ink, and is fixed so as to extend in the vertical direction parallel to the surfaces of the partition wall 23. In this arrangement, the first chamber 21 and the filter chamber 29 are held in communication with each other through the mesh of the planar filter 2f. The base portion has a lower wall which partially defines the filter chamber 29 and which has a through-hole 24 through which the filter chamber 29 is held in communication with the through-hole 31a of the reservoir unit 3, as shown in FIG. 5C.

As shown in FIG. 5A, the planar filter 2f has a parallelogram shape as seen in the horizontal direction of arrangement of the first and second chambers 21, 22, which shape is substantially similar to that of the filter chamber 29. In the filter chamber 29, the filter 2f is positioned to be nearer to the lower wall 21b than to the upper wall 21a, in the vertical direction, so that an upper gap between the upper end of the filter 2f and the upper wall 21a is larger than a lower gap between the lower end of the filter 2f and the lower wall 21b. The larger upper gap prevents the filter 2f to capture and hold the air bubbles which have entered into the first chamber 21. The communication passage 23x is located between the upper wall 21a and the filter 2f in the vertical direction, and is lightly spaced from the filter 2f in the longitudinal direction of the base portion 20 away from the inlet openings 21x, 22x.

The exhaust passage 26b has an opening 26x at its end nearer to the inlet joints 2a-2c. Through this opening 26x, the exhaust passage 26b is held in communication with the connecting passage 7b (FIG. 3A). The base portion 20 has a through-hole 25 through which the exhaust passage 26b is held in communication with the through-hole 31b of the reservoir unit 3.

The partition wall 23 which has the opening at which the filter 2f is fixed, and the communication passage 23x, further has a through-hole 23f formed at an upper corner of the filter chamber 29, and a through-hole 23g communicating with the exhaust passage 26b. The filter chamber 29 is held in communication with the exhaust passage 26a through the through-hole 26f, while the exhaust passage 26a is held in communication with the exhaust passage 26b through the through-hole 26g.

Referring to FIGS. 5A-5C, the ink flows during the printing operation of the ink-jet head 1 will be described.

During the printing operation of the ink-jet head 1, the ink is delivered from the auxiliary tank 60 (FIG. 2) into the filter unit 2 through the inlet joint 2c, as indicated by arrows in FIG. 5A. Described in detail, the ink flows from the inlet joint 2c into the first chamber 21 through the connecting passage 7c (FIG. 3A) and the inlet opening 21x, and then flows through the first chamber 21 toward the filter 2f, as shown in FIG. 5A. The ink then flows from the first chamber 21 into the filter chamber 29 through the filter 2f, as shown in FIG. 5B, and enters into the reservoir unit 3 through the through-hole 24 and the through-hole 31a, as shown in FIG. 5C. The ink which has flown into the reservoir unit 3 through the through-hole 31a flows into the reservoir 33x through the through-hole 32a, and into the individual branch passages of the reservoir 33x. Subsequently, the ink flows into the passage unit 4 through the through-holes 34x and through-holes 4x (FIG. 4). The ink which has entered into the passage unit 4 through the through-holes 4x is distributed into the individual ink passages through the main manifold passages 41 and auxiliary manifold massages 41a, and is ejected from selected ones of the ink ejecting nozzles according to the operations of the actuator units 5 as well known in the art. These flows of the ink are naturally caused as the ink is consumed by the printing operation of the ink-jet head 1 to form the images on the paper sheets P. The through-holes 4x formed in the passage unit 4 are covered by respective filters (not shown). That is, the through-holes 34x and the through-holes 4x are held in communication with each other through this filter, so that the ink flows into the reservoir unit 3 into the passage unit 4 through the filter.

Referring next to FIGS. 6A-6C, the ink flows during the nozzle purging operation of the ink-jet head 1 will be described. The nozzle purging operation is performed to forcibly introduce the ink into the passage unit 4 and eject the ink from the nozzles, for the purpose of eliminating or preventing plugging of the nozzles with the ink. In other words, the nozzle purging operation is performed to discharge the ink having a relatively high degree of viscosity, from the nozzles, for thereby recovering the ink ejecting performance of the nozzles.

During the nozzle purging operation of the ink-jet head 1, the ink is delivered from the main tank 50 (FIG. 2) into the filter unit 2 through the inlet joint 2a, as indicated by arrows in FIG. 6A. Described in detail, the ink flows from the inlet joint 2a into the main space of the second chamber 22 through the connecting passage 7a (FIG. 3A) and the inlet opening 22x, and then flows through the main space and the passage 22e. Then, the ink flows from the passage 22e into the first chamber 21 through the communication passage 23x, as shown in FIG. 6B. The ink then flows which has entered into the first chamber 21 through the communication passage 23x flows into the filter chamber 29 through the filter 2f, and then into the reservoir unit 3 through the through-hole 24 and through-hole 31a, as shown in FIG. 6C. The ink then flows from the reservoir unit 3 into the passage unit 4, and is ejected from the nozzles, as described above with respect to the printing operation of the ink-jet head 1.

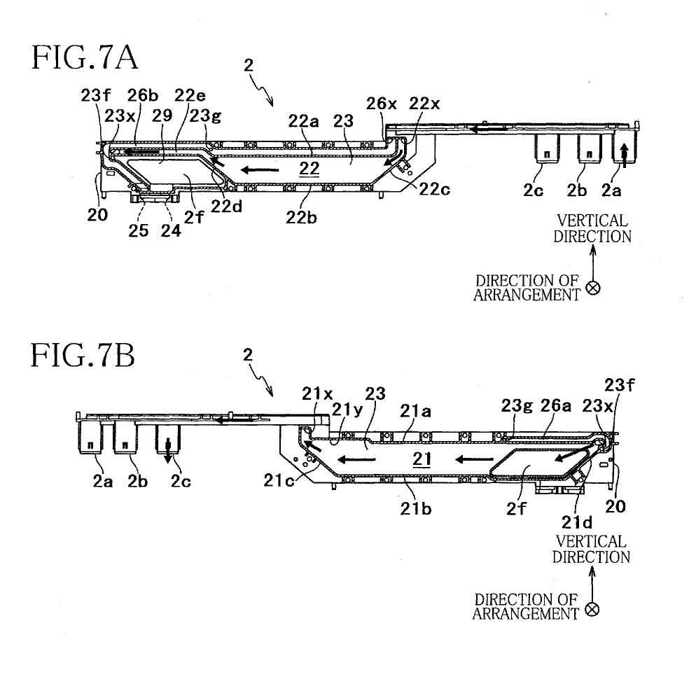

Referring next to FIGS. 7A and 7B, the ink flows during the circulation purging operation of the ink-jet head 1 will be described. The circulation purging operation is performed to forcibly introduce the ink into the filter unit 2 and remote the foreign matters deposited on the filter 2f, together with the ink, for the purpose of eliminating or preventing closing of the filter 2f with the foreign matters. In other words, the circulation purging operation is performed to effectively discharge the air bubbles and other foreign matters from a portion of the filter unit 2 upstream of the filter 2f, out of the ink-jet head 1.

During the circulation purging operation of the ink-jet head 1, the ink is delivered from the main tank 50 (FIG. 2) into the filter unit 2 through the inlet joint 2a, and into the communication passage 23x, as indicated by arrows in FIG. 7A, and as described above with respect to the nozzle purging operation. Then, the ink flows from the communication passage 23x into the first chamber 21, and flows along the surface of the filter 2f to the inlet opening 21x, as shown in FIG. 7B. The ink then flows through the inlet opening 21x and connecting passage 7c (FIG. 3A) into the auxiliary tank 60 through the inlet opening 2c.

Then, the ink flows during the inter-filter purging operation of the ink-jet head 1 will be described by reference to FIGS. 8A-8C. The inter-filter purging operation is performed to forcibly introduce the ink into the filter unit 2 and reservoir unit 3, for the purpose of removing the foreign matters accumulated between the filter 2f of the filter unit 2f and the filters disposed to cover the through-holes 4x open in the upper surface 4b (FIG. 4) of the passage unit 4, such that the foreign matters are discharged together with the ink from the ink-jet head 1.

During the inter-filter purging operation of the ink jet head 1, the ink is delivered from the main tank 50 (FIG. 2) into the filter unit 2 through the inlet joint 2a, and into the communication passage 23x, as indicated by black-line arrows in FIG. 8A, and as described above with respect to the nozzle purging operation. Then, the ink flows from the communication passage 23x into the first chamber 21, as indicated by black-line arrow in FIG. 8B, and flows through the filter 2f into the filter chamber 29, as indicated by broken-line arrow in FIG. 8B and as described above with respect to the nozzle purging operation by reference to FIG. 6B. The ink flows from the filter chamber 29 into the reservoir unit 3 through the through-hole 24, as indicated by black-line arrows in FIG. 8C. The ink which has flown into the reservoir unit 3 through the through-hole 31a flows into the reservoir 33x through the through-hole 32a, and into the individual branch passages of the reservoir 33x. Subsequently, the ink flows toward the filters provided on the upper surface 4b of the passage unit 4.

Then, the ink flows upwards through the through-holes 34x away from the filters on the upper surface 4b, and flows through the through-holes 32 in the end portions of the branch passages of the reservoir 33x, into the recess 32x from which the ink flows into the exhaust passage 26b through the through-hole 31b and through-hole 25, as indicated by white-line arrows in FIG. 8C. The ink which has flown into the exhaust passage 26b flows into the connecting passage 7b (FIG. 3A) through the opening 26x, as indicated by white-line arrows in FIG. 8A, and returns back to the auxiliary tank 60 (FIG. 2) through the inlet joint 2b.

The air bubbles existing in the filter chamber 29 float together on the mass of ink within the filter chamber 29 move together with the ink into the exhaust passage 26a through the through-hole 23f located at the upper corner of the filter chamber 29, and into an intermediate portion of the exhaust passage 26b through the through-hole 23g, as indicated by white-like arrows in FIGS. 8A and 8B. The ink which has entered into the exhausts passage 26b flows together with the air bubbles into the connecting passage 7b (FIG. 3A) through the opening 26x, and returns to the auxiliary tank 60 (FIG. 2) through the inlet joint 2b, as described above.

Each of the ink-jet heads 1 is controlled by the controller 501 (FIG. 1) of the printer 500 to perform the above-described printing operation, nozzle purging operation, circulation purging operation and inter-filter purging operation. In the present printer 500, the purging operations of each ink-jet head 1 are performed at a predetermined regular interval, or upon a predetermined manual operation by the user of the printer 500.

In the ink-jet head 1 constructed as described above according to the preferred embodiment of the invention, the filter 2f is disposed so as to extend in the vertical direction when the four ink-jet heads 1 are arranged in the horizontal direction in the printer 500. Accordingly, the filter 2f having an effective filtering surface area large enough to efficiently capture the foreign matters will not result in an increase in the size of the ink-jet head 1 in the horizontal direction. Further, unlike the filter disposed so as to extend in the horizontal direction, the present filter 2f disposed so as to extend in the vertical direction is unlikely to be clogged with the foreign matters over a large surface area, since the foreign matters contained in the ink tend to move upwards and float on the ink.

It is further noted that the filter 2f is disposed such that a suitable gap space is formed between the upper end of the filter 2f and the lower surface of the upper wall 21a of the first chamber 21, as shown in FIG. 5A, so that the foreign matters can be collected in the gap space above the filter 2f, whereby the foreign matters are unlikely to dwell adjacent to the filter 2f. Thus, the filter 2f is effectively protected against clogging with the foreign matters over a large surface area.

The communication passage 23x for communication between the first and second chambers 21, 22 is formed through a relatively upper portion of the partition wall 23, such that the communication passage 23x are open to the first and second chambers 21, 22, at vertical positions higher than the vertically middle portion of the chambers 21, 22, so that the foreign matters contained in the ink in the two chambers 21, 22 which tend to float upwards easily flow through the communication passage 23x, whereby the foreign matters can be effectively discharged through the communication passage 23, during the circulation purging operation described above by reference to FIGS. A and 7B.

The communication passage 23x is open to the first chamber 21, within the above-described gap space provided between the filter 2f and the upper wall 21a in the vertical direction, so that the foreign matters gathering above the filter 2f can be effectively discharged through the communication passage 23x, during the circulation purging operation described above by reference to FIGS. 7A and 7B.

During the circulation purging operation of the ink-jet head 1, the ink flows into and out of the first and second chambers 21, 22 through inlet and outlet openings that are located at vertical positions higher than the middle position of the chambers 21, 22 as seen in the vertical direction. Described more specifically, one of the opposite open ends of the communication passage 23x, and the inlet opening 21x respectively serve as the inlet and outlet for the first chamber 21, while the other open end of the communication passage 23x and the inlet opening 22x respectively serve as the inlet and outlet for the second chamber 22. These inlets and outlets that are located at the relatively higher positions of the chambers 21, 22 permit effective discharge of the foreign matters that gather in the upper gap space during the circulation purging operation.

The upper wall 21a of the first chamber 21 has the inlet opening 21x through which the ink is introduced into the first chamber 21 during the printing operation of the ink-jet head 1, and the recessed portion 21y which extends from the inlet opening 21x toward the filter 2f in the downstream direction of the ink flow. During the printing operation, the foreign matters contained in the ink introduced into the first chamber 21 through the inlet opening 21x gather in the recessed portion 21y1 and are therefore unlikely to reach the filter 2f. In the absence of the recessed portion 21y, the foreign matters existing in the upper part of the first chamber 21 may be mixed in the ink introduced into the first chamber 21 during the printing operation while the ink flows within the first chamber 21 toward the filter 2f, causing a risk of clogging of the filter 2f with the foreign matters contained in the ink reaching the filter 2f. In the present ink-jet head 1 wherein the recessed portion 21y is formed to retain the foreign matters therein, the ink flowing through the first chamber 21 is unlikely to flow with the foreign matters toward the filter 2f, whereby the filter 2f is protected against clogging with the foreign matters during the printing operation.

Portions of the first chamber 21 adjacent to the inlet opening 21x and the communication passage 23x (serving as an outlet opening) are defined by the lower wall 21b, and the end walls 21c, 21d which are inclined with respect to the lower wall 21b by the respective obtuse angles θ1 and θ2, as seen in the direction of arrangement of the two chambers 21, 22. Similarly, portions of the main space of the second chamber 22 adjacent to the inlet opening 22x and the passage 22e (serving as an outlet opening) are partially defined by the lower wall 22b, and the end walls 22c, 22d which are inclined with respect to the lower wall 22b by the respective obtuse angles θ5 and θ6, as seen in the direction of arrangement of the two chambers 21, 22. If the angles of inclination θ1, θ2, θ5 and θ6 of the end walls 21c, 21d, 22c, 22d with respect to the lower wall 21b, 22b were 90 degrees, for example, collision of the ink flows with the lower wall 21b, 22b would cause secondary ink flows in different directions other than the direction of ink flow from the inlet opening 21x, 22x toward the outlet opening 23x, 22e, particularly when the velocity of the ink flows is relatively high. The secondary ink flows cause mixing of the air bubbles in the ink, and a pressure loss of the ink. The air bubbles once mixed in the ink due to the secondary ink flows are difficult to be released from the ink. The mixing of the air bubbles in the ink and the pressure loss cause a failure of normal ink ejection from the nozzles during the printing operation of the ink-jet head, and a failure of normal purging operations of the ink-jet head (a failure of normal discharge of the foreign matters by the purging operations). In the ink-jet head 1 according to the present invention, however, the angles of inclination θ1, θ2, θ5 and θ6 of the end walls 21c, 21d, 22c, 22d with respect to the lower wall 21b, 22b are determined to be obtuse angles, so as to prevent the generation of the secondary ink flows, and the consequent various problems described above.

Further, the upper wall 21a and the end wall 21c define the portion of the first chamber 21 adjacent to the inlet opening 21x through which the ink flows into the first chamber 21 during the printing operation, and the upper wall 21a and the end wall 21d define the portion of the first chamber 21 adjacent to the communication passage 23x through which the ink flows from the first chamber 21 during the nozzle, circulation and inter-filter purging operations. The end walls 21c, 21d are inclined with respect to the upper wall 21a by the angles θ3 and θ4 of about 40 degrees as seen in the direction of arrangement of the two chambers 21, 22. Similarly, the upper wall 22a and the end wall 22c define the portion of the main space of the second chamber 22 adjacent to the inlet opening 22x through which the ink flows into the second chamber 22 during the purging operations. The end wall 22c is inclined with respect to the upper wall 22a by the angle θ7 of about 40 degrees. These angles of inclination θ3, θ4 and θ7 also contribute to prevention of the generation of the secondary ink flows and consequent various problems.

The filter 2f has the parallelogram shape as seen in the direction of arrangement of the two chambers 21, 22. This parallelogram shape of the filter 2f is partially defined by the upper wall 21a, end wall 21d and lower wall 21b which are formed such that the end wall 21d connecting the upper and lower walls 21a and 21b is inclined with respect to the lower wall 21b by the obtuse angle of θ2 as seen in the direction of arrangement of the two chambers 21, 22. Unlike a circular, rectangular or any other shape the front and back surfaces of which are seen to be symmetrically identical with each other in the opposite directions, the parallelogram shape of the filter 2f has the front and back surfaces having symmetrically different shapes as seen in the opposite directions, so that the filter 2f can be easily fixed in the filter unit 2, with its front and back surfaces facing in the right directions.

Each of the first and second chambers 21, 22 is partially defined by the vertically extending wall including the flexible film 27 opposed to the partition wall 23 in the direction of arrangement of the two chambers 21, 22, as shown in FIG. 3B. The flexible films 27 function to reduce the amount of variation of the ink pressure within the first and second chambers 21, 22. Namely, the flexible films 27 have a pressure damping effect with respect to the ink within the chambers 21, 22. Further, the flexible films 27 which extend in the vertical direction can be given a surface area large enough to effectively perform the pressure damping effect, without a considerable increase of the size of the ink-jet head in the horizontal direction.

Further, the flexible film 27 of each chamber 21 is backed by the metal sheet 28 formed such that the flexible film 27 is interposed between the partition wall 23 and the flexible film 27 in the direction of arrangement of the two chambers 21, 22, as also shown in FIG. 3B. The metal sheet 28 functions as a rigid sheet member to prevent a damage of the flexible film 27.

The partition wall 23 and the first and second chambers 21, 22 have larger horizontal dimensions than vertical dimensions, as seen in the direction of arrangement of the two chambers 21, 22, as is apparent from FIGS. 5A and 5B. Accordingly, the ink flows through the first and second chambers 21, 22, during the circulation purging operations, for example, in the longitudinal directions of the chambers 21, 22, as indicated in FIGS. 7A and 7B. Thus, the ink flows through the first and second chambers 21, 22 by a relatively long distance in the horizontal direction, so that the foreign matters are likely to be captured in the chambers 21, 22 before the foreign matters reach the ink ejecting nozzles, and discharged from the ink-jet head 1 during the circulation purging operation.

Further, each chamber 21, 22 has a rectangular cross sectional shape as seen in the direction perpendicular to the direction of arrangement of the chambers 21, 22, having a larger dimension in the vertical direction than a horizontal dimension in the direction of arrangement, as shown in FIG. 5B. Accordingly, the four ink-jet heads 1 can be arranged in the secondary scanning direction, at a relatively small pitch of arrangement, as shown in FIG. 1, so that the printer 500 can be accordingly small-sized. In addition, the small pitch of arrangement of the ink-jet heads 1 requires a reduced distance of feeding of the paper sheet P from the moment of starting and finishing of the image printing operation on the paper sheet P, and accordingly permits an increased efficiency of the image printing operation, and an improvement of the image quality owing to a reduced chance of dislocation of ink dots of different colors corresponding to the four ink-jet heads 1.

While the preferred embodiment of the present invention has been described above by reference to the drawings, for illustrative purpose only, it is to be understood that the present invention is not limited to the details of the illustrated embodiment, but may be embodied with various changes and modifications, which may occur to those skilled in the art, without departing from the spirit and scope of the invention defined in the appended claims.

In the illustrated embodiment, the principle of the present invention applies to a liquid-flow space through which a liquid in the form of the ink flows and which is partially defined by a partition portion in the form of the partition wall 23 in the filter unit 2 superposed on the reservoir unit 3. However, the principle of the invention is equally applicable to any liquid-flow space formed in a portion of in the ink-jet head 1 other than the filter unit 2.

Although the filter 2f of the ink-jet head 1 according to the illustrated embodiment is disposed so as to extend in the vertical direction, the filter may be disposed so as to extend in any direction which intersects the horizontal direction and which is inclined with respect to the vertical direction.

In the illustrated embodiment, the partition portion in the form of the partition wall 23, and the first and second chambers 21, have larger dimensions in the horizontal direction, as seen in the direction of arrangement of the two chambers 21, 22. However, the partition portion and the two chamber 21, 22 may have larger dimensions in the vertical direction, provided the filter is disposed so as to extend in a direction intersecting the horizontal direction, for reducing an increase in the size of the ink-jet head in the horizontal direction and a chance of clogging of the filter with the foreign matters over a large surface area.

The printer 500 including the ink-jet heads 1 according to the preferred embodiment has been described above, with the particular directions of ink flows through the first and second chambers 21, 22 during the printing and purging operations, particular positions of the ink inlet and outlet openings (including the communication passage 23x) of the chambers 21, 22, and particular positions of the ink inlet and outlet passages with respect to the chambers 21, 22. However, each ink-jet head 1 may be otherwise configured. In the illustrated embodiment wherein the first and second chambers 21, 22 are elongate in the horizontal direction as seen in the direction of arrangement of the two chambers 21, 22, the ink flows through the first and second chambers 21, 22 in the horizontal direction parallel to the longitudinal direction of the chambers 21, 22 from the ink inlet opening at one end of each elongate chamber to the ink outlet opening at the other end. However, the chambers may be formed so that the ink flows in the vertical direction.

Further, the ink-jet head may be configured such that the ink flows in a direction different from the longitudinal direction of the two chambers (as seen in the direction of arrangement of the two chambers), that is, may flow in the direction perpendicular to the longitudinal direction. It is also noted that the recessed portion 21y defined by the upper wall 21a of the first chamber 21 may be eliminated. Although the communication passage 23x for communication between the first and second chambers 21, 22 are open at a vertical position between the filter 2f and the upper walls 21a, 22a in the illustrated embodiment, the communication passage 23x may be replaced by a communication passage open at a position within the vertical dimension of the filter, or at a position below the filter.

In the illustrated embodiment, the first and second chambers 21, 22 have an inverted trapezoidal cross sectional shape as seen in the direction of arrangement of the two chambers 21, 22, as shown in FIG. 5A However, the shape of the first and second chambers 21, 22 is not limited to the inverted trapezoidal shape. Further, the angles of inclinations θ1-θ8 (indicated in FIGS. 5A and 5B) of the end walls 21c, 21d, 22c, 22d with respect to the upper and lower walls 21a, 21b, 22a, 22b may be suitably determined.

In the illustrated embodiment, the filter 2f has a parallelogram shape as seen in the direction of arrangement of the two chambers 21, 22, as shown in FIG. 6A. However, the shape of the filter 2f is not limited to the parallelogram shape. Further, the filter 2f disposed below the upper wall 21a in the illustrated embodiment may be disposed in contact with the upper wall 21a.

While the filter 2f is disposed in the second chamber 22, the filter 2f may be disposed in the second chamber 22, or two filters may be provided in the respective two chambers 21, 22.

In the illustrated embodiment, each of the side walls of the first and second chambers 21, 22 opposed to each other in the direction of arrangement of the two chambers 21, 22 is a laminar structure consisting of the flexible film 27 and the metal sheet 28, as shown in FIG. 3B. However, each side wall may consist of only the flexible film 27, or any other member. The metal sheet 28 is an example of a rigid member, and may be replaced by any rigid member other than a metallic member.

In the illustrated embodiment, both of the side walls of the first and second chambers 21, 22 opposed in the direction of arrangement of the two chambers 21, 22 are provided with the flexible film 27 and the metal sheet 28, as shown in FIG. 3B. However, only one of the opposite side walls may be provided with the flexible film 27, or the metal sheet 28.

The liquid ejecting head according to the present invention may be of either a line printing type or a serial printing type, and may be used in an apparatus other than the printer, for example, in a facsimile or copying apparatus. The liquid ejecting head of the invention may use a liquid other than an ink.

Although the ink-jet head 1 according to the illustrated embodiment of this invention uses the piezoelectric actuator units 5 configured to eject the liquid from the nozzles, the ink-jet head may use other types of actuator such as an electrostatic type and a resistor-heating thermal type.

What is claimed is:

1. A liquid ejecting head comprising:
a structure defining a liquid-flow space through which a liquid flows from a liquid supply source toward a plurality of liquid-drop ejecting nozzles;
a generally planar partition portion formed so as to extend in a direction intersecting a vertical direction and configured to partially define the liquid-flow space;
the partition portion partially defining a first chamber and a second chamber such that the first and second chamber are arranged in a horizontal direction on respective opposite sides of the partition wall, the first and second chambers having a larger dimension in the vertical direction than that in the horizontal direction, in cross section taken in a plane parallel to the vertical direction and the horizontal direction of arrangement of the first and second chambers; and
a planar filter fixed to the partition portion so as to extend in a direction intersecting the horizontal direction, along a surface of the partition portion, and configured to capture foreign matters contained in the liquid in at least one of the first and second chambers.

2. The liquid ejecting head according to claim 1, wherein the filter is disposed below an upper wall of the at least one of the first and second chambers such that a gap space is formed between the filter and the upper wall.

3. The liquid ejecting head according to claim 2, wherein the upper wall of the at least one of the first and second chambers extends in a substantially horizontal direction.

4. The liquid ejecting head according to claim 1, further comprising another structure defining a communication passage for communication between the first and second chambers, and a vertical position at which the communication passage is open to the at least one of the first and second chambers is higher than a vertically middle portion of the at least one of the first and second chambers.

5. The liquid ejecting head according to claim 2, further comprising another structure defining a communication passage for communication between the first and second chambers, and a vertical position at which the communication passage is open to the at least one of the first and second chambers is located between the filter and the upper wall in the vertical direction.

6. The liquid ejecting head according to claim 5, wherein the communication passage is a through-hole formed through a portion of the partition portion between the filter and the upper wall in the vertical direction.

7. The liquid ejecting head according to claim 1, wherein said one of the first and second chambers has a first opening through which the liquid flows into the at least one of the first and second chambers during a circulation purging operation of the liquid ejecting head wherein the liquid flows out of the at least one of the first and second chambers after flowing along a surface of the filter, and further has a second opening through which the liquid flows out of the at least one of the first and second chambers during the circulation purging operation, the first and second openings being located at vertical positions higher than a vertically middle portion of the at least one of the first and second chambers.

8. The liquid ejecting head according to claim 7, wherein the liquid purging operation is performed to cause the liquid supplied from the liquid supply source to flow along the surface of the filter in the at least one of the first and second chambers, and out of the liquid ejecting head through an outlet different from the liquid-drop ejecting nozzles.

9. The liquid ejecting head according to claim 1, wherein the at least one of the first and second chambers has an upper wall having an inlet opening through which the liquid is introduced into the at least one of the first and second chambers during a printing operation of the liquid ejecting head to eject droplets of the liquid from the liquid-droplet ejecting nozzles, and the upper wall partially defines a recessed portion which extends in a downstream direction from the inlet opening toward the filter.

10. The liquid ejecting head according to claim 1, wherein the at least one of the first and second chambers has at least one of an inlet opening through which the liquid flows into the at least one of the first and second chambers, and an outlet opening through which the liquid flows out of the at least one of the first and second chambers, a lower wall, and an end wall inclined with respect to the lower wall by an obtuse angle as seen in the horizontal direction of arrangement of the first and second chambers, at least one of a portion of said one chamber adjacent to the inlet opening and a portion of said chamber adjacent to the outlet opening being partially defined by the lower and end walls.

11. The liquid ejecting head according to claim 1, wherein the at least one of the first and second chambers has an upper wall, a lower wall parallel to the upper wall, and an end wall which connects the upper and lower walls and which is inclined with respect to the lower wall by an obtuse angle as seen in the horizontal direction of arrangement of the first and second chambers, and the filter has a parallelogram shape as seen in the horizontal direction of arrangement of the two chambers.

12. The liquid ejecting head according to claim 1, wherein the at least one of the first and second chambers is partially defined by a side wall which is opposed to the partition portion in the horizontal direction of arrangement of the first and second chambers and which includes a flexible film extending in a direction intersecting the horizontal direction

13. The liquid ejecting head according to claim 12, wherein the side wall further includes a rigid sheet member formed to back the flexible film such that the flexible film is interposed between the partition portion and the rigid sheet member.

14. The liquid ejecting head according to claim 1, wherein the partition portion, and the first and second chambers have larger dimensions in the horizontal direction than in the vertical directions, as seen in the horizontal direction of arrangement of the first and second chambers, and the liquid flows through the first and second chambers in longitudinal directions of the first and second chambers as seen in the horizontal direction of arrangement of the first and second chambers.

15. The liquid ejecting head according to claim 1, further comprising a lowermost structure having a substantially horizontally extending liquid-drop ejecting lower surface in which the plurality of liquid-drop ejecting nozzles are open.
